(19) United States
(12) Patent Application Publication
(10) Pub. No.: US 2003/0006968 A1
(43) Pub. Date: Jan. 9, 2003

(54) Close form factor PDA detachable keyboard

(76) Inventor: Robert Solomon, Bainbridge Island, WA (US)

Correspondence Address: PATRICK M. DWYER PC, 1818 WESTLAKE AVENUE N, SUITE 114, SEATTLE, WA, 98109, US

(21) Appl. No.: 10/138,789

(22) Filed: May 3, 2002

Related U.S. Application Data
(60) Provisional application No. 60/288,776, filed on May 4, 2001.
(60) Provisional application No. 60/303,486, filed on Jul. 6, 2001.

(51) Int. Cl. G09G 5/00

(52) U.S. Cl. 345/168

(57) ABSTRACT

A detachable keyboard for a PDA. The keyboard and the PDA have respective form factors and the keyboard has an alphanumeric arrangement of keys and a PDA cradle operatively associated with the keyboard. The keyboard form factor and the PDA form factor have close integration with each other.

This application claims priority to U.S. provisional applications Nos. 60/288,776 and 60/303,486 filed May 4, 2001 and Jul. 6, 2001, respectively.

### TECHNICAL FIELD

The invention relates generally to computer input devices; more particularly it relates to a key input apparatus and to methods for data input for handheld computing devices and PDAs; more particularly it relates to a close form factor PDA detachable keyboard.

### BACKGROUND OF THE INVENTION

The increase in variety of and number of end users of handheld computing devices, including pagers, palmtop computers, email receivers and other so called Personal Digital Assistants (PDAs), and even data ready cell phones, is nothing short of phenomenal. With few current exceptions however, such PDA devices have no real or effective keyboard input, designed as they were to occupy a minimum of palm real estate and to be primarily graphical user interface (GUI) input driven, typically through the use of a stylus, or the like, with the user pointing her input by touching various icons on the PDA screen. This is of course also true for cell phones, except that numerical keys are present, and generally no GUI is enabled.

The current exception to the GUI-centric Palm® or Visor® type PDA is represented in RIM's Blackberry® email-centric palmtops. The Blackberry devices have built in keyboards, and thus effectively smaller view/touch screens, but have optimized text input via the keyboard. This is particularly noticeable in the Blackberry model that has roughly the same form factor as the other palm handhelds. All such PDA's provided with factory keyboards are keyboard committed, in that the keyboard is not removable, so applications that are not text intensive run in a more limited environment on the Blackberry that on more typical palm-type PDAs.

However, the obvious advantages of the current GUI-centric PDAs in non-text intensive applications are sometimes outweighed by the cumbersome, even tedious, implementation of even rudimentary text input that is the common lot of these devices.

Attempts to meet the need posed by the text-unfriendly PDAs are numerous; a number of keyboards have been proposed for use in conjunction with a keyboardless PDA. Some keyboards of a more or less conventional nature are provided with cabling that attaches to an optional port in the PDA or to the PDA's docking port (typically provided for synchronization of the PDA with a host or mother computer on which resides a master version of contact and time management software also running on the PDA). Other relatively conventionally sized keyboards are proposed that provide a docking port of their own for receiving the PDA into docking relationship with the keyboard. Both such proposals have the disadvantage that the relatively large keyboard is an antithesis in concept to the palm form factor itself. Few users will want to carry a keyboard around for use with their PDA, especially when the keyboard is many times larger and more cumbersome than the PDA; and after all if the user only needs to enter text when at home or at the office, the normal PDA/computer docking arrangement is enough to enable such text input from the computer's own keyboard.

Other proposals that address in some measure this space/portability concern include a foldable keyboard that opens up to a nearly full size keyboard, a pivot attached smaller keyboard that nearly obscures the view screen of the PDA to which it is attached, and a piggyback stacked arrangement of a Palm device and a smaller keyboard. Such keyboards all trade utility, as measured by the standard of a full size QWERTY keyboard, for size reduction; yet they remain relatively cumbersome in totage, and also problematic in usage. They are either non-intuitive in their hookup or attachment to the PDA and require at least some measure of departure from the “zen of Palm” in that the resulting hookup no longer looks or continues to function like the handheld before the attachment. As users of such handheld devices tend toward having strong opinions about maintaining the purity and detachment of their handheld, such keyboard proposals are not likely to meet the needs stated above in a way that a PDA user will actually want to employ.

What is needed is a keyboard input device for a PDA that is integrated closely to the PDA form factor, that is removable, and that preferably provides for the PDA to dock into the removable keyboard in such a way that is intuitive and that does not significantly change the form factor of the PDA or the way in which it is used. The removable keyboard will also store readily and be portable with the usual kit bag or case in which the PDA is carried.

### DISCLOSURE OF THE INVENTION

This disclosure addresses and provides such a system. The disclosed system represents several optimal embodiments of a keyboard input device for particular PDAs. The form factor of each keyboard is integrated closely to the form factor of the particular PDA for which the keyboard model is designed. Each keyboard is removable, and preferably provides for the PDA to releasably and lockably dock into a recess or bay in the keyboard in an intuitive manner. Surprisingly, such a keyboard does not significantly alter the form factor of the PDA or the way in which it is used. The removable keyboard itself is relatively small and light for easy and ready storage and portability with the usual kit bag or case in which the PDA is carried.

A detachable keyboard for a PDA is disclosed, both the keyboard and the PDA having respective form factors, the keyboard comprising an alphanumeric keyboard, and a PDA cradle operatively associated with the keyboard optimally for receiving the PDA to establish a docked connection between the keyboard and the PDA, wherein the keyboard form factor and the PDA form factor have close integration with each other. In some embodiments, the keyboard may dock below the PDA and substantially coplanar with the PDA, so that the PDA is docked on the keyboard, but not in a bay or recess. The terms ‘form factor’ and ‘close integration’ or ‘closely integrated’ are specially defined herein and have particular meanings as herein set forth.

Generally a form factor for either the keyboard or the PDA, respectively, may advantageously be thought of as, or viewed as, any one of several different planar projection patterns, for instance, plan (or front) view projections and side elevation projections. For example, imagine a keyboard or PDA held above a blank sheet of paper beneath a strong light; the respective shadow cast on the paper would be one kind of planar projection of the keyboard or PDA. If the keyboard or PDA is held flat, with screen facing the user or viewer, then the projection pattern is a plan or front projection; if the keyboard or PDA is held with one side facing upwards towards the light, then the projection pattern is a side elevation projection. Each projection pattern can usefully be thought of as having both a pattern area and a pattern boundary for purposes of comparison and analysis of close integration of respective form factors.

The term ‘close integration’ of keyboard form factor with PDA form factor can mean one of several related things, such as:

a) having a percentage keyboard pattern area that lies outside the PDA pattern boundary by about 0-30%, and preferably 2-10%, of the keyboard pattern area;

b) having a percentage PDA pattern area that is covered by or otherwise obscured by the keyboard pattern area by no more than about 15-35% of the PDA pattern area (by no more than about 20% of the PDA pattern area if the PDA has no graffiti area or soft key icons); or

c) having a percentage PDA pattern boundary that is covered by the keyboard pattern area by no more than about 20-50%, and preferably about 40%, of the PDA pattern boundary.

Any of these kinds of form factor overlap or close coverage as illustrated, or any combination of them, produce the kind of ‘close integration’ of form factors referred to in this disclosure. It should be noted, and will be appreciated by those skilled in the art, that the various preferred percentage differences expressed herein my be modified in PDA/keyboard systems and still maintain respectable functionality and form factor integration; therefore variance from the percentage figures or ranges given do not depart from the intended scope of the invention. The figures given however generally produce superior results and user satisfaction.

In a variation on close integration, a PDA has a screen with a screen area, the screen optionally has a graffiti area, and the graffiti area generally has one or more soft key icons located in the area. Close integration of keyboard form factor with PDA form factor is effected in this instance by having a percentage screen area that is covered by the keyboard pattern area by no more than about −10%-+15% (and preferably 0-10%) of the screen area. For negative percentages that the keyboard pattern area actually stops short of covering any of the screen area by the indicated negative percentage. For instance, close integration of 10% would refer to 10% of the screen area being covered by the keyboard pattern area, while close integration of −10% would refer to all the screen area being uncovered by the keyboard pattern area, with a space equivalent to about 10% of the screen area also uncovered below the bottom of the screen area.

For purposes of calculating close integration, the graffiti area, if any, is not included in the screen area. Optionally, the graffiti area is also not covered, or alternatively only partially covered, by the keyboard, and for this option the keyboard is smaller and advantageously does not have soft key replacement buttons.

The keyboard advantageously uses a switchable power source, switchable between at least two of the group of power sources consisting of internal battery power, external battery power, a PDA power source and an external line power source. An electronically controlled auto power off for the keyboard is optionally provided.

The keyboard preferably has a releasable lock whereby a PDA may be releasably engaged and/or locked in the keyboard's PDA cradle. In some embodiments, this lock may advantageously take the form of a non-slip friction fit between the PDA body and the interior walls of the keyboard's PDA bay, preferably enhanced by 2 or more ridges projecting into the interior of the bay and running longitudinally in the bay in contacting relationship with one of the surfaces of the PDA body.

An alternate embodiment of the disclosed keyboard and PDA system has an alternate PDA with snap on cover feature enabled, and also has a snap on keypad to snap on to PDA via a tang visible through keypad window. The keypad area of the snap on keypad covers approximately and proportionately the same area as the embodiments discussed above.

In another variation, the close integration of the keyboard and PDA form factors is satisfied when a planar projection pattern area of the keyboard is between 15-35% of the area of a planar projection pattern area of the PDA, and the PDA is in docking connection with the keyboard. The PDA is docked onto the keyboard so the keyboard is disposed immediately below, and substantially coplanar with, the PDA.

A releasable lock mechanism for a PDA docking bay in a keyboard is also disclosed. The docking bay has a front and a rear wall, one of which is preferably substantially thinner than the other, and the lock is essentially the friction gripping effect of a plurality of ridges of relatively non-slip, compressible material raised along one wall, together with the spring compression action of a slightly distended thinner wall.

A novel method of providing an alphanumeric input to a keyboardless PDA is also disclosed. The method has the following steps: attaching a keyboard to the PDA (or vice versa) where the PDA's form factor is a close integration to the keyboard form factor; electronically connecting the PDA to the keyboard so the keyboard covers a lower portion of the PDA, up to and including a softkey bar or graffiti area at the bottom of the view screen of the PDA; triggering the display of a setup menu on the PDA view screen, the menu having ‘setup’, ‘custom layout’, ‘restore defaults’, ‘preview’, and ‘about’ items and/or the like, and a check box or the like soft switch for keyboard enablement, all for user input; responsive to user input, either switching to a new screen for a selected menu item, or enabling the keyboard; inputting user selected alpha-numeric and miscellaneous characters into the PDA processor for display of the selected characters on the PDA screen.

### BRIEF DESCRIPTION OF THE DRAWINGS

FIG. 1 is a perspective front view of an embodiment of the disclosed keyboard and PDA system.

FIG. 2 is an exploded perspective side view of one embodiment of the keyboard.

FIG. 3 is an exploded perspective side view of another embodiment of the keyboard.

FIG. 4 is a schematic plan view of an aspect of the keyboard PDA system.

FIG. 5 is a schematic plan view of another aspect of the keyboard PDA system.

FIG. 6 is a front view of an alternate keypad layout of the system.

FIG. 7 is a front view of an alternate keypad layout of the system.

FIG. 8 is a front view of an alternate keypad layout of the system.

FIG. 9 is a perspective front view of an alternate embodiment of the disclosed keyboard and PDA system.

FIG. 10 is an exploded bottom view of an embodiment of the keyboard and case.

FIG. 11 is an exploded top view of an embodiment of the keyboard and case.

FIG. 12 is a front view of an alternate keypad layout of the system.

FIG. 13 is a front view of an alternate keypad layout of the system.

FIG. 14 is a front view of an alternate keypad layout of the system.

FIG. 15 is a schematic cross-sectional view along lines 15-15 in FIG. 6.

FIG. 16 is a schematic plan view of an alternate PDA/keyboard close integration.

### BEST MODE OF CARRYING OUT THE INVENTION

The keyboard is generally detachable from the PDA at will and has a modified standard QWERTY key layout optimized for smallest size and for thumb input by one or more of the following: a) 26 alpha characters of English alphabet arranged in same three rows as standard QWERTY, but offset from standard so that the Q is arranged directly above the A and so that each character in the Q row is substantially vertically aligned with each character in the A row, and the Z row is preferably offset to the right so the Z is aligned underneath the S or the D; b) numerals 1-0 are overlapped on the alpha keys Q-P respectively and accessed via a concurrent press of the shift key, or other designated control-type key; c) backspace and return are preferably vertically aligned respectively beneath the P; d):/+−=_“‘ and @ keys are overlapped on the alpha keys A-L respectively and also conventionally accessed via a concurrent press of a control-type key; e) the */tab key is aligned substantially vertically beneath the A key; and f) $( )#&!,? keys are overlapped on the keys Z-. (period) respectively, and accessed as above. The three alpha rows are arranged in respectively upwardly arcing lines (like a smile pattern), and the bottom center of each arc is generally centered over the space bar. The space bar advantageously doubles as a toggle for screen-based pseudo keyboard input.

The keyboard preferably also has one or more of the following: a) one to four ‘shadowed’ keys for the calendar, phonebook, to do list and memo pad softkeys normally visible in the view screen's bottom (or so called ‘graffiti’) bar, the keys preferably arranged generally below the space bar, with the keys symmetrically disposed on either side of a scroll up key and scroll down key centered beneath the spacebar; and b) one to four ‘shadowed’ keys for the home, menu, power and search/find hard keys generally otherwise accessible on the front of the PDA. An optional ‘assign’ key that can be assigned as a hotkey for a PDA application of choice is also available. Portal, email and calculator access functions are overlapped on the to do, memo and search/find keys respectively in some embodiments, and accessed as are other doubled keys disclosed herein.

Turning now to the drawings, the invention will be described in a preferred embodiment by reference to the numerals of the drawing figures wherein like numbers indicate like parts.

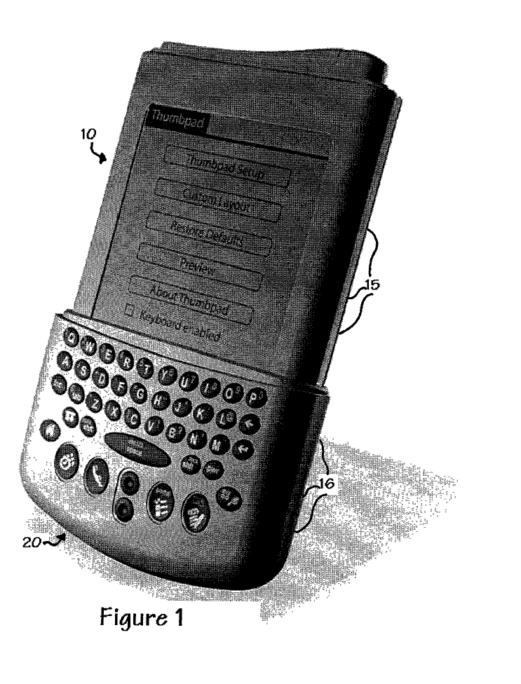

FIG. 1 shows PDA 10 docked within a bay in keyboard 20. Keyboard 20 is in close integration of its form factor with the form factor of the PDA, as can readily be seen. PDA pattern boundary 15 and keyboard pattern boundary 16 are illustrated; note that the percentage by which the outer limit of keyboard pattern boundary 16 is outside PDA pattern boundary 15 is relatively small. A user of PDA 10 need change none of her habits in handling the PDA as she docks and uses keyboard 20. Keyboard 20 advantageously draws on PDA power and does not require removal just to put the PDA in a pocket or snug case, though it can easily be removed and redocked at will and stored in its own case or bag.

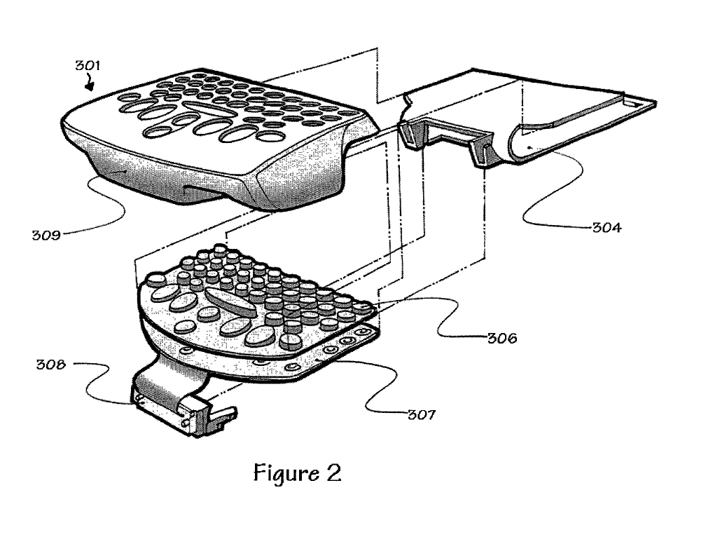

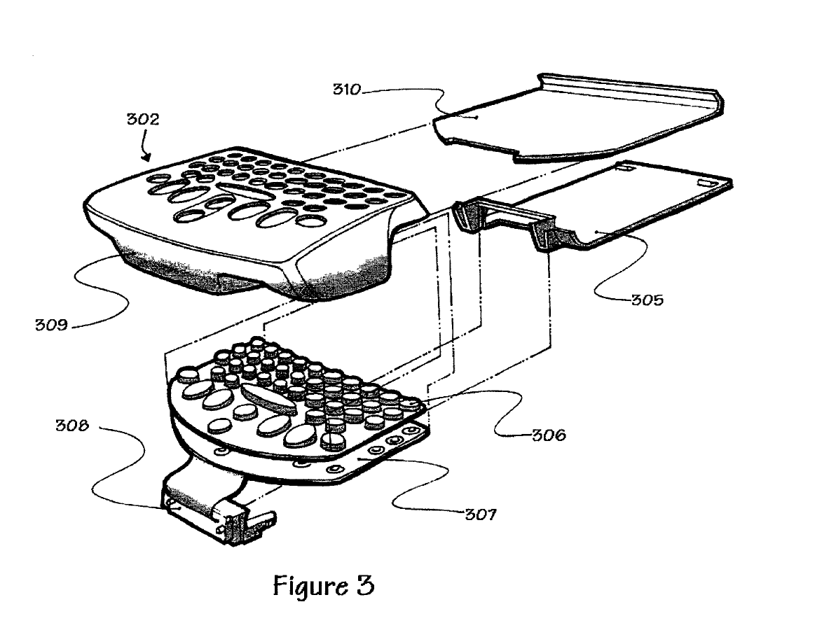

FIGS. 2 and 3 show alternate exploded embodiments of keyboards 301 and 302 respectively. Each keyboard has housing 309, keypad 306, PCB 307 and connector 308, arranged and assembled as shown. Keyboard 301 features a unit chassis 304, while keyboard 302 features a two part chassis that includes an attachment chassis 305 and keypad backing panel 310.

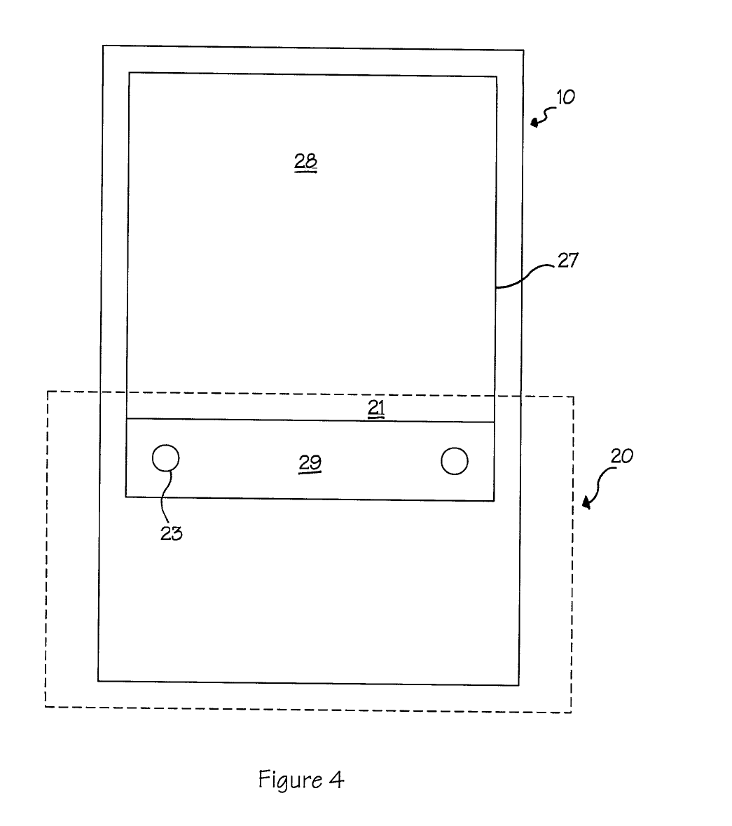

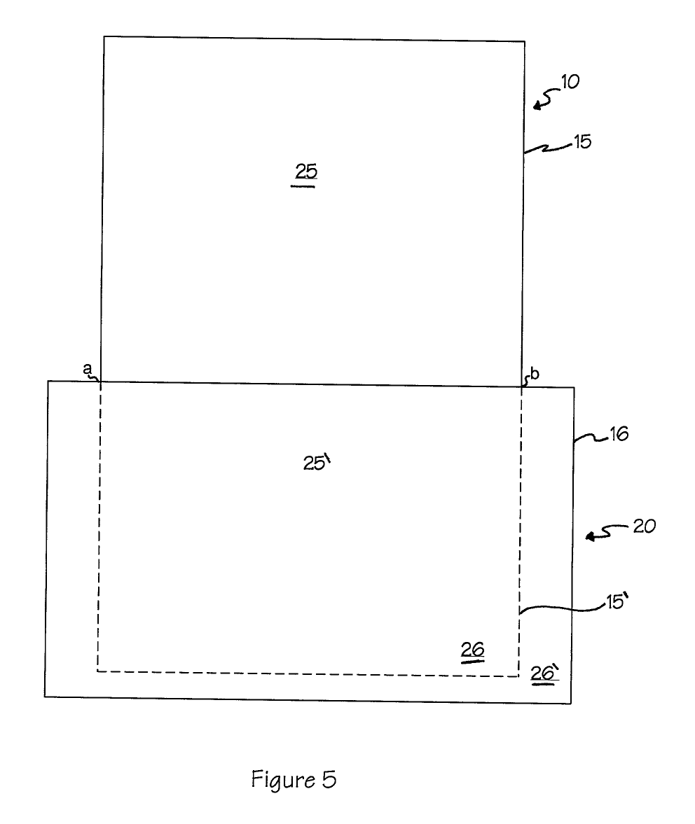

FIGS. 4 and 5 illustrate the close integration criteria disclosed and claimed herein. In FIG. 4, PDA 10 has screen 27 and graffiti area, or bottom bar, 29 with two softkey icons 23 shown. Screen 27 has screen area 28. Keyboard 20 is illustrated partially overlapping the area of screen 27 and impinging or covering a percentage of screen area 28, with the covered portion of the screen area 28 designated as screen overlap 21. In practice and depending on the keyboard/PDA combination, this screen overlap 21 can represent 0-15% of the total screen area 28. In some embodiments, the upper boundary of keyboard 20 with cross the PDA in such a way as to impinge only in the graffiti area, or even below the graffiti area, and thus take up none of screen area 28. This is said to be negative percentage coverage, and may be up to −10%, and in some instances even more negative. It is believed that optimal balance between effective screen are availability and large enough keyboard size may be effected with an overlap area 21 that is 0-10% of screen area 28.

In FIG. 5, PDA 10 has pattern boundary 15 and pattern area 25, while keyboard 20 has pattern boundary 16 and pattern area 26. The part of PDA pattern area 25 that is covered by keyboard pattern area 26 is 25′; the part of keyboard pattern area 26 that is outside of, or overlaps, PDA pattern boundary 15 is 26′; the part of PDA pattern boundary 15 that is covered or interdicted by pattern boundary 16 (at points a and b, with the covered portion of the PDA pattern boundary shown dotted) is 15′.

For non-exclusive examples, if 15′ is 40% of 15 then it meets one of the criteria, among others, disclosed for close integration. If 26′ is about 10% of keyboard pattern area 26, then it also meets one of the criteria, among others, disclosed for close integration. If 25′ is about 35% of PDA pattern area 25, then it also meets one of the criteria, among others, disclosed for close integration.

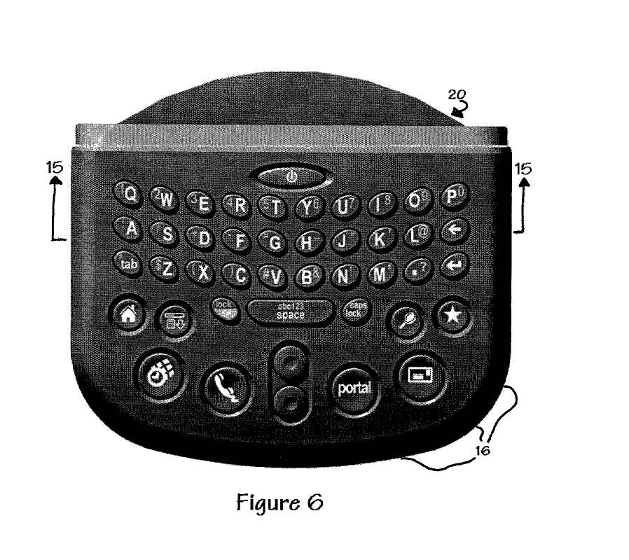

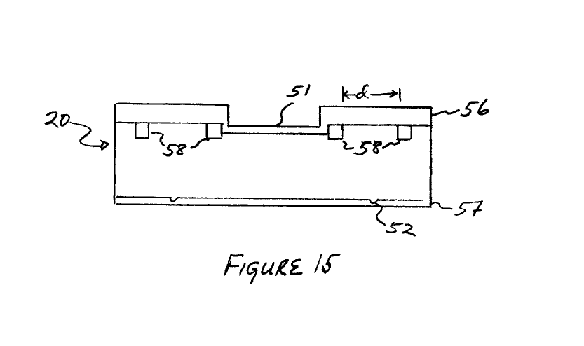

FIG. 6 illustrates a preferred keyboard and case embodiment 20. Docking bay (not visible) is open upwardly as oriented in the drawing. FIG. 15 schematically shows a section though the bay along lines 15-15 of FIG. 6. Pattern boundary 16 is also illustratively marked. One possible keypad arrangement is also shown. In particular the ‘star’ key, or assignment key, is shown, which may be selectably programmed to hotkey a favorite PDA application.

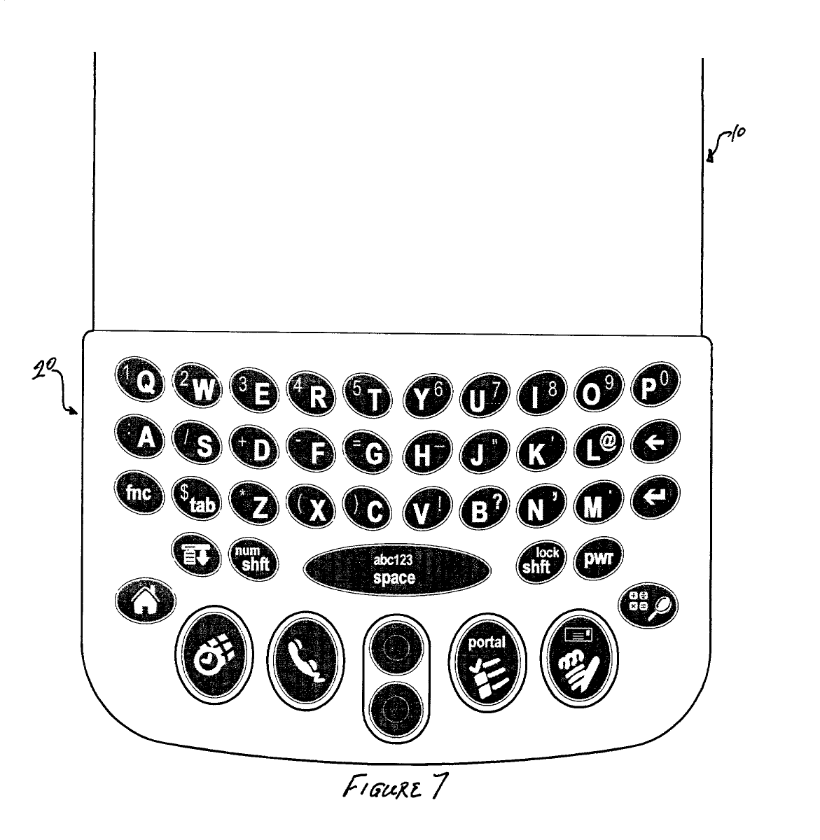

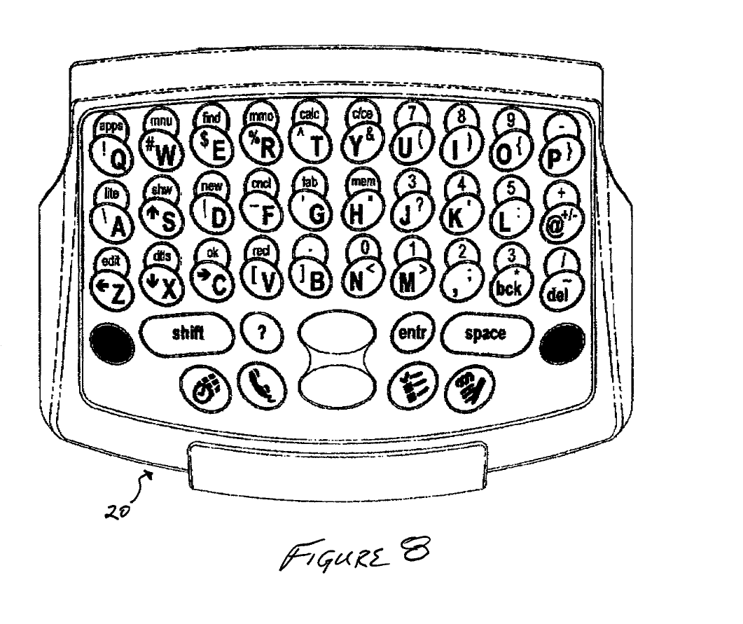

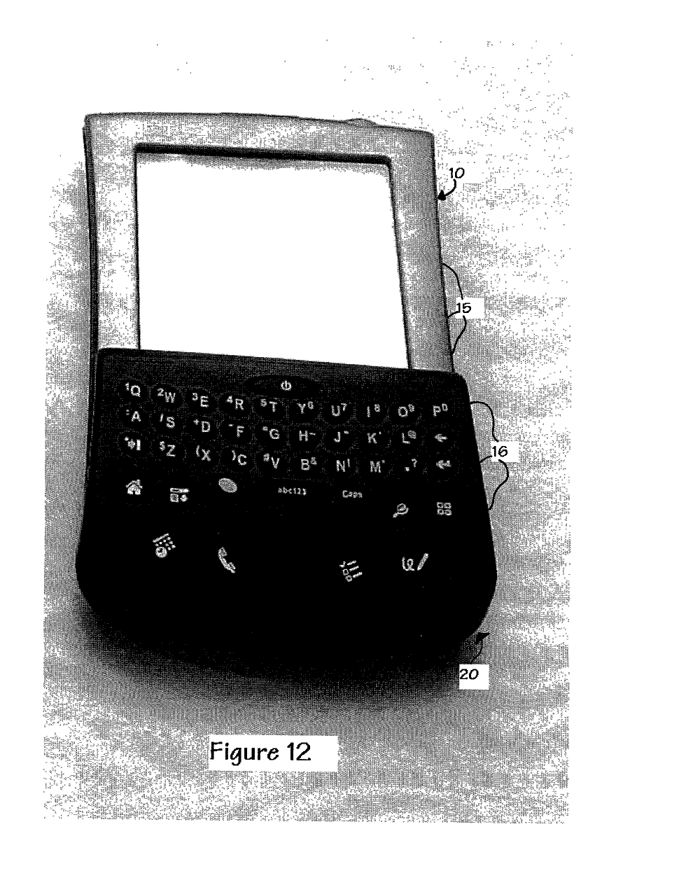

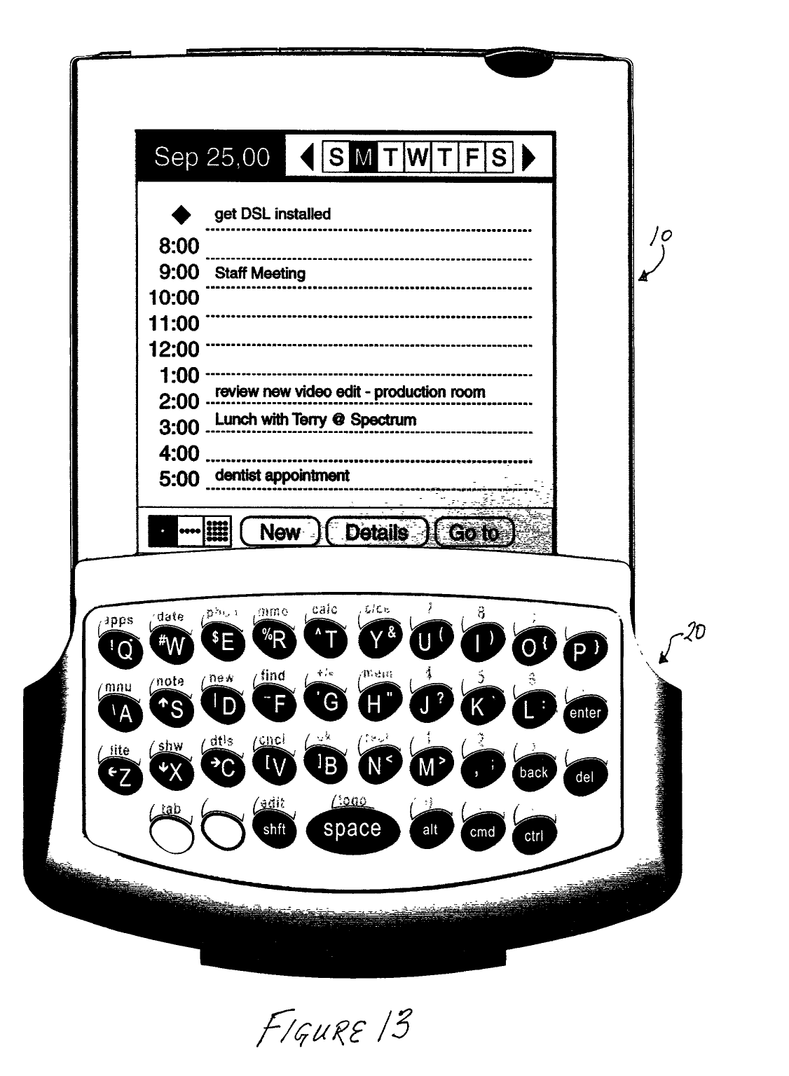

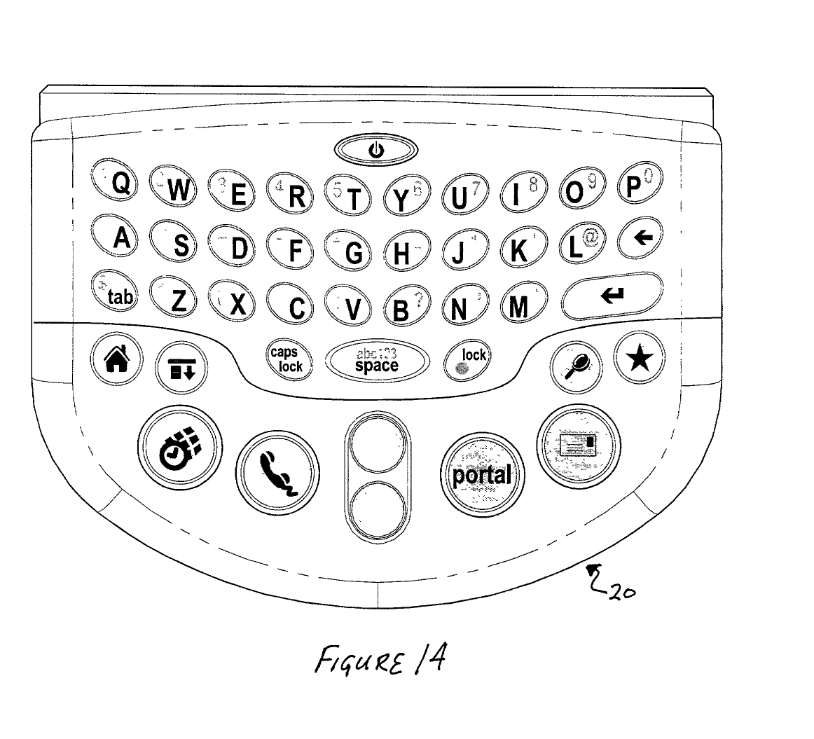

FIGS. 7, 8, 12, 13 and 14 show alternate embodiments of keyboard 20 for different PDA's and also alternate keypad and alphanumeric key arrangements. In FIG. 12 in particular, respective pattern boundaries 15 and 16 are also illustratively marked.

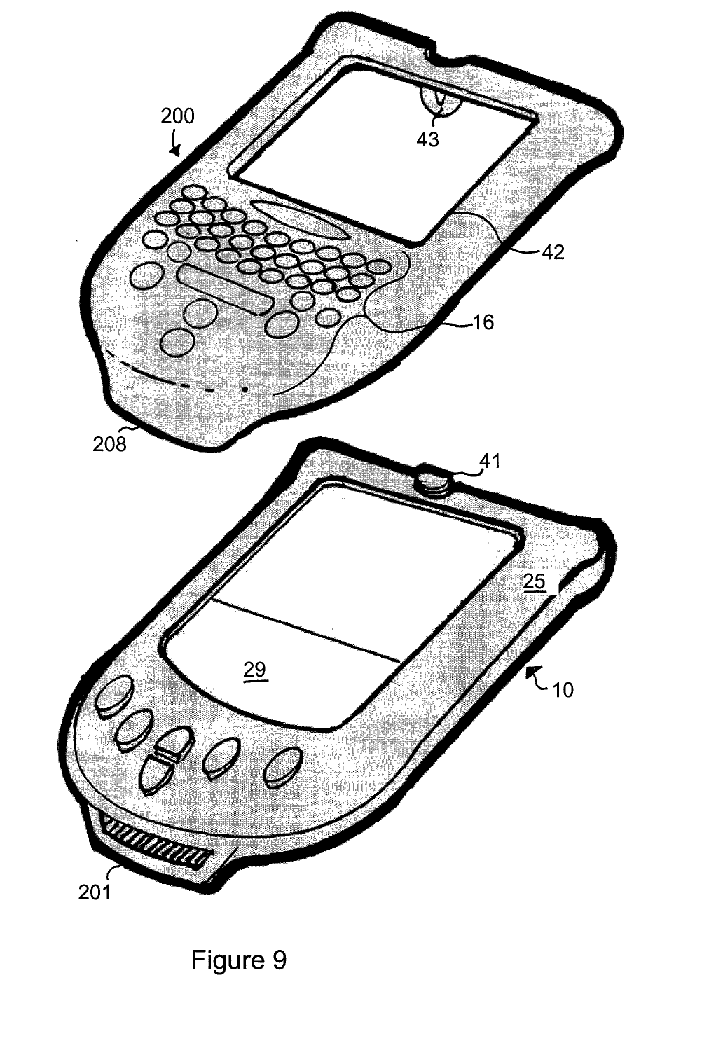

In FIG. 9, an alternate embodiment of keyboard 200 shows PDA 10 with snap on cover feature enabled, and with snap on keypad 200 poised to snap on to PDA in the direction of the arrow via tang 43 visible through keypad fenestration 42, and showing keypad area 16 of snap on keypad with window 42 covering approximately and proportionately the same area as the embodiments in FIGS. 4 and 5. Keyboard tang 43 is releasably connectable to the PDA tang 41 (for instance on a Palm M105) where the PDA cover otherwise attaches; keyboard connector 208 fits securely into PDA sync port 201 for data and electrical docking and for secure but releasable fit of keyboard 200 onto PDA 10. Keypad area 16 covers the lower portion of PDA 10, including the PDA buttons, and most or all of graffiti area 29; however, most of PDA pattern area 25 is not obstructed by keyboard 20, and in particular, most if not all of the PDA screen is still accessible and viewable, even with the snap on keyboard attached. This is yet another illustration of close integration of respective form factors.

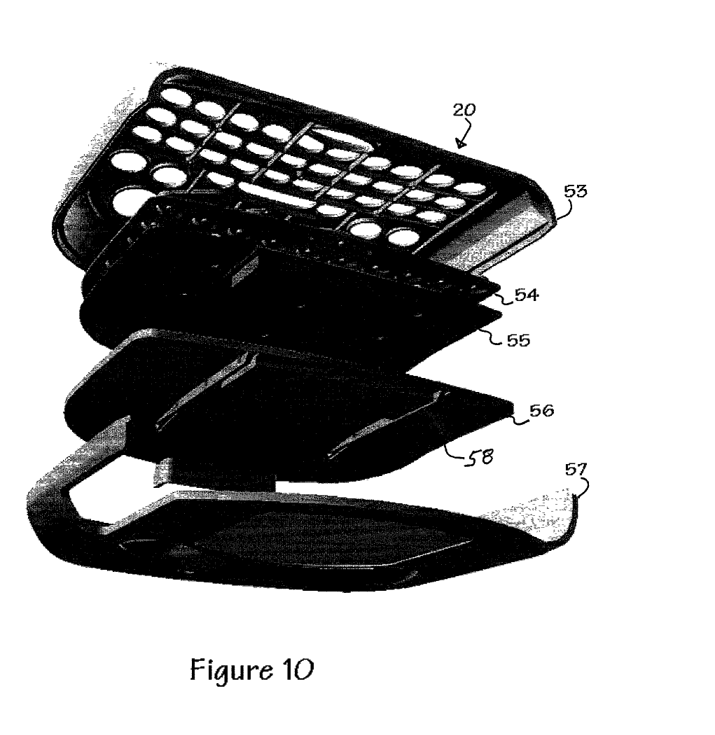

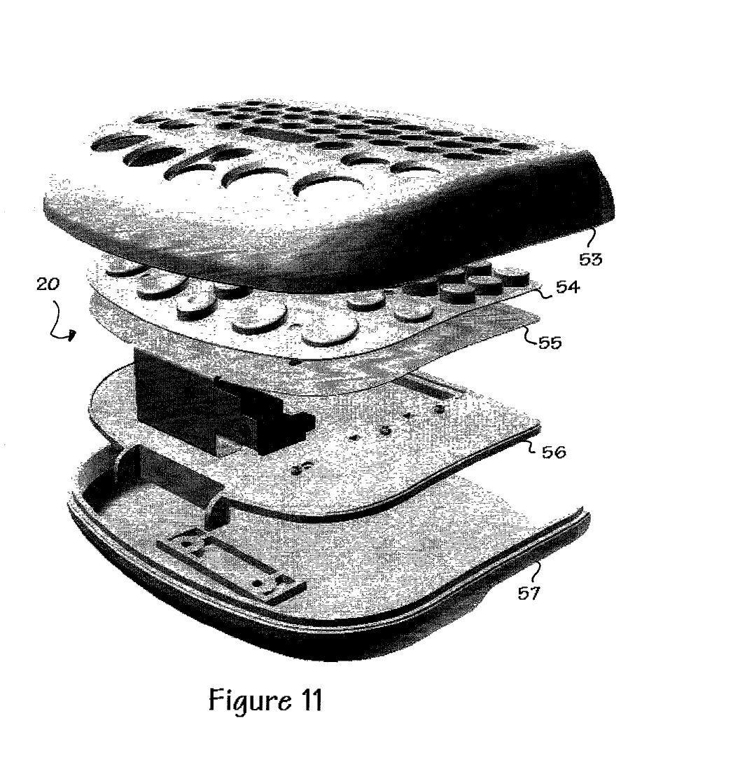

In FIGS. 10 and 11, a preferred embodiment of keyboard 20 is exploded and viewed from both top and bottom to illustrate to those skilled in the art how a preferred keyboard may be assembled. Keypad 54 beds on PCB 55 which is assembled onto attachment chassis 56. This assembly is held securely in mated top case 53 and bottom case 57. One embodiment of the friction grip ridges 58 is also shown in FIG. 10.

In FIG. 15, a kind of releasable lock mechanism for a PDA docking bay 59 in keyboard 20 is shown. Docking bay 59 has a front and a rear wall, comprised of attachment chassis 56 and bottom case 57, respectively, one of which is preferably substantially thinner (in this instance, bottom case 57) than the other, and the lock is essentially the friction gripping effect of a plurality of ridges 58 of relatively non-slip, compressible material raised along one wall (in this instance, chassis 56), together with the spring compression action of the slightly distended thinner wall 57. Ridge placement and wall dimensions can be interchanged at need, and the ridges can even be raised from the thinner wall.

Each ridge is made preferably of Sanoprene or the like material having a non-slip but slide enabled finish and moderate compressibility characteristics. Various other moderately hard rubbers will also occur to those skilled in the plastic and rubber selection arts where friction and compressibility have interplay. The idea of the ridges of the ‘flexible fit’ docking arrangement in general is to allow the keyboard 20 to fit more than one PDA where size differences are otherwise small or minor. The ridge mechanism also provides a relatively secure grip by the bay around the PDA so that the keyboard does not just fall off when gripping only the PDA. Ridges 58 compress slightly when a PDA of appropriate size range is inserted into bay 59, and thin wall 57 distends slightly with spring compression action to effectively grip the PDA. In some embodiments extra grooves 52 in one of the bay walls help the grip and to some extent allow greater flexibility in the bending wall. Preferred placement of ridges 58 on chassis 56 is one on either side of the chip cavity 51 and another pair spaced about 7/16-11/16″ from the inner pair of ridges, preferably about 19/32″ o.c., as shown schematically. Ridges 58 are about 1/16″ wide each (range 3/64-5/64 typ.) and each just tall enough to clear chip housing 51 so as to present a friction surface to entering PDA 10. Each ridge is preferably about 1½″ long, as are optional grooves 52.

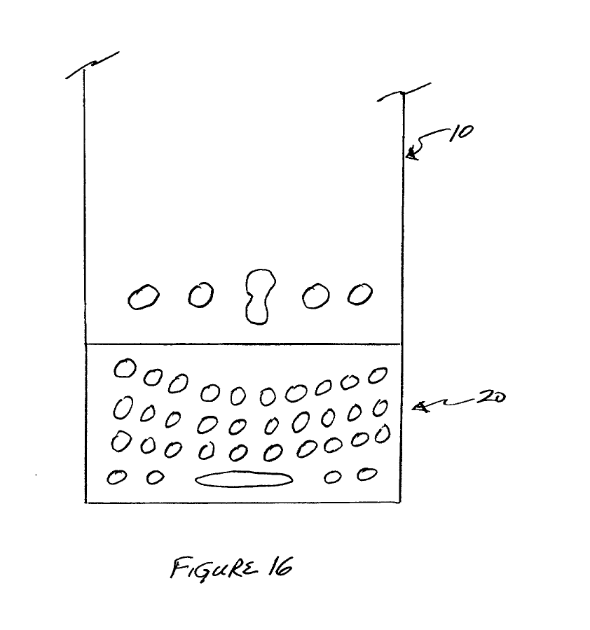

In FIG. 16, keyboard 20 is docked to PDA 10 in such a way as to cover none of the PDA and to leave its buttons clear for use. Thus keyboard 20 need not have ‘shadowed’ buttons (though it optionally may have them), and the keyboard can be smaller. Keyboard 20 meets one of the close integration criteria by being only a small fraction of the size of the PDA.

With regard to systems and components above referred to, but not otherwise specified or described in detail herein, the workings and specifications of such systems and components and the manner in which they may be made or assembled or used, both cooperatively with each other and with the other elements of the invention described herein to effect the purposes herein disclosed, are all believed to be well within the knowledge of those skilled in the art. No concerted attempt to repeat here what is generally known to the artisan has therefore been made.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A detachable keyboard for a PDA, the keyboard and the PDA each having respective form factors, the keyboard comprising an alphanumeric arrangement of keys, and a PDA cradle operatively associated with the keyboard, wherein the keyboard form factor and the PDA form factor have close integration with each other.

2. The keyboard of claim 1 wherein the keyboard and the PDA form factors respectively are each comprised of at least one planar projection pattern each from the group of planar projection patterns consisting of a plan view projection pattern and at least one side elevation projection pattern, each projection pattern having a pattern area and a pattern boundary, and wherein the close integration of keyboard form factor with PDA form factor comprises one of the close integrations from the group of close integrations consisting of a) a percentage keyboard pattern area that is outside the PDA pattern boundary of between 0 and 30%, and preferably 2% to 10%; b) a percentage PDA pattern area that is covered by the keyboard pattern area of between 15 and 35%; and c) a percentage PDA pattern boundary that is covered by the keyboard pattern area of between 20 and 50% and preferably about 40%.

3. The keyboard of claim 1, the PDA further comprising a screen having a screen area, the screen having a graffiti area, the graffiti area optionally having one or more soft key icons therein, wherein the close integration of keyboard form factor with PDA form factor comprises coverage of a percentage screen area by the keyboard of between −10% and +15%, the screen area not including the graffiti area for purposes of calculating close integration.

4. The keyboard of claim 2 wherein the keyboard further comprises a modified standard QWERTY key layout optimized for smallest size and for thumb input with 26 alpha characters of English alphabet arranged in the same three rows as standard QWERTY, but offset from standard so that the Q is arranged directly above the A and so that each character in the Q row is substantially vertically aligned with each character in the A row, and the Z row is offset to the right so the Z is aligned underneath the S or the D, the three alpha rows arranged in respectively upwardly arcing lines, the bottom center of which arcs are generally centered over the space bar.

5. The keyboard of claim 4 further comprising a switchable power source, switchable between at least two of the group of power sources consisting of internal battery power, external battery power, a PDA power source and an external line power source.

6. The keyboard of claim 4 further comprising a releasable lock whereby a PDA may be releasably engaged in the PDA cradle.

7. The keyboard of claim 4 further comprising a) at least one ‘shadowed’ key for the calendar, phonebook, to do list, memo pad and other like softkeys generally otherwise visible in the PDA view screen's bottom bar, the key(s) arranged generally below and centered beneath the space bar, with multiple keys, if any, symmetrically disposed on either side of an scroll up key and scroll down key centered beneath the spacebar; and b) at least one ‘shadowed’ key for the home, menu, pwr and search/find hard keys generally otherwise accessible on the front of the PDA.

8. The keyboard of claim 1 further comprising a switchable power source, switchable between at least two of the group of power sources consisting of internal battery power, external battery power, a PDA power source and an external line power source.

9. The keyboard of claim 8 further comprising a releasable lock whereby the PDA may be releasably engaged in the PDA cradle.

10. The keyboard of claim 1 wherein the close integration of the keyboard and PDA form factors is that a planar projection pattern area of the keyboard is between 15-35% of the area of a planar projection pattern area of the PDA, and the PDA is in docking connection with the keyboard.

11. The keyboard of claim 10 wherein the PDA is docked onto the keyboard so the keyboard is disposed immediately below, and substantially coplanar with, the PDA.

12. A detachable keyboard for a PDA, the keyboard and the PDA each having respective form factors, the keyboard optimized for two thumb input with a modified standard QWERTY key layout having 26 alpha characters of English alphabet arranged in same three rows as standard QWERTY, but offset from standard so that the Q is arranged directly above the A and so that each character in the Q row is substantially vertically aligned with each character in the A row, and the Z row is offset to the right so the Z is aligned underneath the S or the D, the three alpha rows arranged in respectively upwardly arcing lines, the bottom center of which arcs are generally centered over the space bar.

13. The keyboard of claim 12 further comprising a PDA cradle operatively associated with the keyboard.

14. The keyboard of claim 12 wherein the keyboard form factor is closely integrated to the PDA form factor, wherein the keyboard and the PDA form factors respectively are each comprised of at least one planar projection pattern each from the group of planar projection patterns consisting of a plan view projection pattern and at least one side elevation projection pattern, each projection pattern having a pattern area and a pattern boundary, and wherein the close integration of keyboard form factor with PDA form factor comprises one of the close integrations from the group of close integrations consisting of a) a percentage keyboard pattern area that is outside the PDA pattern boundary of between 0 and 30%, and preferably 2% to 10%; b) a percentage PDA pattern area that is covered by the keyboard pattern area of between 15 and 35%; and c) a percentage PDA pattern boundary that is covered by the keyboard pattern area of between 20 and 50% and preferably about 40%.

15. The keyboard of claim 13 wherein the keyboard form factor is closely integrated to the PDA form factor, wherein the keyboard and the PDA form factors respectively are each comprised of at least one planar projection pattern each from the group of planar projection patterns consisting of a plan view projection pattern and at least one side elevation projection pattern, each projection pattern having a pattern area and a pattern boundary, and wherein the close integration of keyboard form factor with PDA form factor comprises one of the close integrations from the group of close integrations consisting of a) a percentage keyboard pattern area that is outside the PDA pattern boundary of between 0 and 30%, and preferably 2% to 10%; b) a percentage PDA pattern area that is covered by the keyboard pattern area of between 15 and 35%; and c) a percentage PDA pattern boundary that is covered by the keyboard pattern area of between 20 and 50% and preferably about 40%.

16. The keyboard of claim 15 wherein the close integration of the keyboard and PDA form factors is that a planar projection pattern area of the keyboard is between 15-35% of the area of a planar projection pattern area of the PDA, and the PDA is in docking connection with the keyboard, and wherein the PDA is docked onto the keyboard so the keyboard is disposed immediately below, and substantially coplanar with, the PDA.

17. A detachable keyboard for a PDA, the keyboard and the PDA each having respective form factors, wherein the keyboard comprises: a) at least one ‘shadowed’ key for the calendar, phonebook, to do list, memo pad and other like softkeys generally otherwise visible in the PDA view screen's bottom bar, the key(s) arranged generally below and centered beneath the space bar, with multiple keys, if any, symmetrically disposed on either side of an scroll up key and scroll down key centered beneath the spacebar; and b) at least one ‘shadowed’ key for the home, menu, pwr and search/find hard keys generally otherwise accessible on the front of the PDA.

18. A method of providing an alphanumeric input to a keyboardless PDA, the method comprising the following steps: attaching a closely form factor fitted keyboard to the PDA to electronically connect the PDA to the keyboard and to cover a lower portion of the PDA, up to and including a softkey bar at the bottom of the view screen of the PDA; triggering the display of a thumbpad setup menu on the PDA view screen, the menu having thumbpad setup, custom layout, restore defaults, preview, and about thumbpad items and a check box or the like soft switch for keyboard enablement, all for user input; responsive to user input, either switching to a new screen for a selected menu item, or enabling the thumbpad keyboard; inputting user selected alpha-numeric and miscellaneous characters into the PDA processor for display of the selected characters on the PDA screen.

19. A releasable lock mechanism for a PDA docking bay in a keyboard, the docking bay having a front and a rear wall, one of which is substantially thinner than the other, the lock comprising the friction gripping effect of a plurality of ridges of relatively non-slip, compressible material raised along one wall, together with the spring compression action of a slightly distended thinner wall.

20. The keyboard of claim 19 wherein the thinner wall contains at least one groove.

21. The keyboard of claim 2 wherein the planar projection patterns are a plan view projection patterns, and the close integration of keyboard form factor with PDA form factor comprises a percentage keyboard pattern area that is outside the PDA pattern boundary of between 2% to 10%.

22. The keyboard of claim 3, wherein the close integration of keyboard form factor with PDA form factor comprises coverage of a percentage screen area by the keyboard of about +10%.
